(19) United States
(12) Patent Application Publication
(10) Pub. No.: US 2020/0058034 A1
(43) Pub. Date: Feb. 20, 2020

(54) EVENT CORRELATION THREAT SYSTEM

(71) Applicant: BANK OF AMERICA CORPORATION, Charlotte, NC (US)

(72) Inventors: Brandon Sloane, Santa Barbara, CA (US); Regina Yee Cadavid, San Gabriel, CA (US); John Brian Costello, Long Beach, CA (US)

(73) Assignee: BANK OF AMERICA CORPORATION, Charlotte, NC (US)

(21) Appl. No.: 16/105,777

(22) Filed: Aug. 20, 2018

(51) Int. Cl. G06Q 30/00; G06F 9/48

(52) U.S. Cl. CPC G06Q 30/0185; G06F 21/554; G06F 9/4818

(57) ABSTRACT

Threats may be determined for events in isolation, however, many threats are not identified and/or realized without the occurrence of two or more events. The invention allows for identifying, prioritizing, and remitting the threats that may occur as a result of the combination of events. The invention utilizes the creation of a threat framework, which is populated with events that are defined by event characteristics using an N-tuple. Each event may have an event threat magnitude, as well as an event threat vector that illustrates the severity and likelihood of the event threat and the alignment of the threat event with related threats, and which can be used to determine an event threat assessment for the combination of events. The one or more threat frameworks may be represented by plotting the events in a dimensional Cartesian space illustrating the event threat magnitude and event threat vector.

### FIELD

The present invention relates to event threat systems, and more particularly to event correlation systems that are utilized to identify and remediate threats within an organization.

### BACKGROUND

Organizations institute systems and procedures for identifying threats and implementing resource changes. It is difficult for organizations to identify threats, implement resource changes, and identify how the changes affect threat priorities.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer implemented methods, and computer products are described herein for determining threats based on combinations of events, and remediating such threats by implementing changes with respect to the events. It should be understood that while threats may be determined for events in isolation, many threats are not identified and/or realized without the occurrence of two or more events (e.g., regardless of timeframe, in parallel, in series, and/or the like, or combinations thereof). As such, the present invention allows for identifying, prioritizing, and mitigating the threats that may occur as a result of combination of events from a plurality of events.

As will be described herein, the events may be anything that is occurring or could occur within an organization, such as, any type of information that is stored, the resources (e.g., systems, applications, or the like that the organization utilizes), any action that a system or user may take within the business, entitlements of systems or users with respect to operation of the organization, processes of the organization or lack thereof, security measures in place or lack thereof, or anything else related to the organization. Each of these events within the organization inherently relate to one or more threats that could occur as a result of the occurrence of the event or combinations of events (e.g., past events, current events, or the occurrence of the events in the future). The threats may be any type of threat, such as but not limited to exposure of customer information, potential system failures, potential security threats, potential damage to computer systems based on natural disasters, system downtime, vendor threats, customer attrition, confidential information disclosure, or any other like threat that could occur within an organization.

As will be discussed in further detail herein, the systems allow for the creation of one or more threat frameworks. The threat frameworks may be populated with events and each of the events comprise event characteristics that may be defined using an N-tuple (e.g., a sequence of elements associated with the event). The event characteristics associated with the event may include the resources (e.g., systems, applications, information, or the like) associated with the event, the importance of the resources, the users associated with the event, the user entitlements for the user associated with the event, the security around the event (e.g., what has to be done in order for the event to occur), or the like. The event characteristics of each event may be used to determine one or more event threat assessments that measure the threat for comparison against thresholds and/or each other for prioritization. As such, each event may have an event threat magnitude (e.g., determination of the severity of the threat caused by the event in combination with the likelihood of the event resulting in the threat, or other like threat measurement), as well as an event threat vector that illustrates how aligned the event is with the threat, as will be discussed in further detail herein. The one or more threat frameworks may include one or more events that are plotted in one or more dimensional Cartesian spaces illustrating both the event magnitude and direction of the event with respect to one or more threats.

It should be understood that while individual events may be a low threat or no threat at all, the combination of individual events may result in a threat, or a greater threat. It should be understood that systems typically only identity singular threats (e.g., a single event that could result in the loss of organization information (e.g., customer information, or other confidential information). Moreover, it is difficult to identity the existence of threats and/or quantify the threats with respect to combinations of events, mitigate the threats, and/or continue to monitor the threats as the event characteristics change. More specifically, it should be understood that normal events within the operation of business may become potential threats only after the normal event is combined with one or more other events (e.g., another normal event, or another event that is a potential threat on its own, or combinations thereof). As such, the combination of normal organization events could result in a potential threat, and alternatively, the combination of a normal organization event and a minor event that is a threat could result in a greater threat, or the like, as will be discussed in further detail herein. The present invention solves the problems of current threat systems by providing a data driven approach to identify, quantify, represent, and remediate the threat, in some cases automatically, as will be described herein. Moreover, the present invention improves the speed of the system through which the threats may be identified, monitored over time, and remediated through the use of the relational databases for the threat framework (e.g., with the plurality of events) and through the use of the N-tuples used to define the event characteristics, which may be easily updated when event changes occur and used to reprioritize the threats.

Embodiments of the invention comprise event correlation threat system for remediation of threats. The invention comprises accessing two or more events and one or more threats from one or more threat frameworks, determining one or more combined event threats for the two or more events, determining a combined event threat assessment for the one or more combined event threats based on an event threat magnitude and an event threat vector for each of the two or more events, and presenting the one or more combined event threats to a user.

In other embodiments, the invention further comprises constructing the one or more threat frameworks, defining a plurality of events within the one or more threat frameworks, wherein defining the plurality of events comprises defining event characteristics within an N-tuple for each of the plurality of events, and determining the event threat magnitude and the event threat vector for each of the plurality of events based at least in part on the N-tuple with the event characteristics.

In still other embodiments of the invention, the one or more threat frameworks are one or more dimensional Cartesian spaces of the plurality of events.

In yet other embodiments of the invention, determining the combined event threat assessment for the one or more combined event threats comprises determining directions of the event threat vector for the two or more events within the one or more dimensional Cartesian spaces that are directed to a threat from the one or more threats, determining the event threat magnitude for the one or more threats, combining event threat magnitudes for the two or more events for the threat based on event threat vectors for the threat, and applying a magnifier from a plurality of magnifiers for the event threat magnitudes to determine the combined event threat assessment.

In further accord with embodiments of the invention, the one or more combined event threats comprise a plurality of combined event threats, and the invention further comprises determining priorities for the plurality of combined event threats based on the combined event threat assessment for the plurality of combined event threats.

In other embodiments of the invention, presenting the one or more combined event threats to the user comprises transmitting for display an event threat interface illustrating a graphical representation of the plurality of events, the one or more threats, and the one or more combined event threats.

In still other embodiments of the invention, presenting the one or more combined event threats to the user comprises transmitting a notification to the user of the plurality of events, the one or more threats, and the one or more combined event threats.

In yet other embodiments, the invention further comprises receiving a selection from the user for the two or more events, in order to determine the one or more combined event threats for the two or more events selected.

In still other embodiments, the invention further comprises automatically receiving a selection from a system for the two or more events in order to determine one or more combined threats for the two or more events selected.

In further accord with embodiments, the invention further comprises monitoring the two or more events, determining when at least one of the two or more events occur, and notifying the user of an occurrence of the at least one of the two or more events or prevent one or more of the two or more events.

In other embodiments, the invention further comprises automatically remediating the one or more combined event threats by editing one or more configurations for one or more resources or entitlements for users associated with the two or more events to reduce the combined event threat assessment for the two or more events.

In still other embodiments, the invention further comprises identifying changes to the event characteristics for at least one of the two or more events, implementing updated event characteristics within the N-tuple for the two or more events within the one or more threat frameworks, and determining an updated event threat assessment for the two or more events based on the updated event characteristics.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, and wherein:

FIG. 1 illustrates a block diagram of a combined event threat system environment, in accordance with one or more embodiments of the invention.

FIG. 2 illustrates a combined event threat identification and remediation process, in accordance with one or more embodiments of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Generally, systems, computer implemented methods, and computer products are described herein for determining threats based on combinations of events, and remediating such threats by implementing changes with respect to the events. It should be understood that while threats may be determined for events in isolation, many threats are not identified and/or realized without the occurrence of two or more events (e.g., regardless of timeframe, in parallel, in series, and/or the like, or combinations thereof). As such, the present invention allows for identifying, prioritizing, and mitigating the threats that may occur as a result of the combination of events from a plurality of events.

As will be discussed in further detail herein, the systems allows for the creation of one or more threat frameworks. The threat frameworks may be populated with events and each of the events comprise event characteristics that may be defined using an N-tuple (e.g., a sequence of elements associated with the event). The event characteristics associated with the event may include the resources (e.g., systems, applications, information, or the like) associated with the event, the importance of the resources, the users associated with the event, the user entitlements for the user associated with the event, the security around the event (e.g., what has to be done in order for the event to occur), or the like. The event characteristics of each event may be used to determine one or more event threat assessments that measure the threat for comparison against thresholds and/or each other for prioritization. As such, each event may have an event threat magnitude (e.g., determination of the severity of the threat caused by the event in combination with the likelihood of the event resulting in the threat, or other like threat measurement), as well as an event threat vector that illustrates how aligned the event is with the threat, as will be discussed in further detail herein. The one or more threat frameworks may include one or more events that are plotted in one or more dimensional Cartesian spaces illustrating both the event magnitude and direction of the event with respect to one or more threats.

It should be understood that while individual events may be a low threat or no threat at all, the combination of individual events may result in a threat, or a greater threat. It should be understood that systems typically only identify singular threats (e.g., a single event that could result in the loss of organization information, such as customer information, or other confidential information), or other like threats. Moreover, it is difficult to identify the existence of threats and/or quantify the threats with respect to combinations of events, mitigate the threats, and/or continue to monitor the threats as the event characteristics change. More specifically, it should be understood that normal events within the operations of an organization may become potential threats only after the normal event is combined with one or more other events (e.g., another normal event, or another event that is a potential threat on its own, or combinations thereof). As such, the combination of normal organization events could result in a potential threat, and alternatively, the combination of a normal organization event and a minor event that is a threat could result in a greater threat, or the like, as will be discussed in further detail herein.

As a general example, a user that has access to sensitive organization information (e.g., employee human resources information, customer information, confidential information, or the like) may be typical and usual for the organization because of the user's job description. Moreover, the user has access to e-mail, which in and of itself is allowable and typical within the organization. However, should the user try to transfer organization information of a certain size (e.g., greater than 5, 10, 20, 30 MB) it may be an event that when viewed as a combination of events could trigger the occurrence of a threat. This may be an example of allowed events that individually are not a potential threat, but the combination thereof could be result in a potential threat. Moreover, should the same user access a file sharing application, this second action, which may in and of itself be a threat (e.g., the organization does not allow users to access file sharing applications), the combination of these events may result in an elevated threat to the organization that would not be elevated when compared to the threat of another user accessing a file sharing website, should such user not have access to the organizational information (e.g., a low threat).

The present invention solves the problems of current threat systems by providing a data driven approach to identify, quantity, represent, and remediate the threat, in some cases automatically, as will be described herein. Moreover, the present invention improves the speed of the system through which the threats may be identified, monitored over time, and remediated through the use of the relational databases for the threat frameworks (e.g., with the plurality of events) and through the use of the N-tuples used to define the event characteristics, which may be easily updated when event changes occur and used to reprioritize the threats, as will be described in further detail herein.

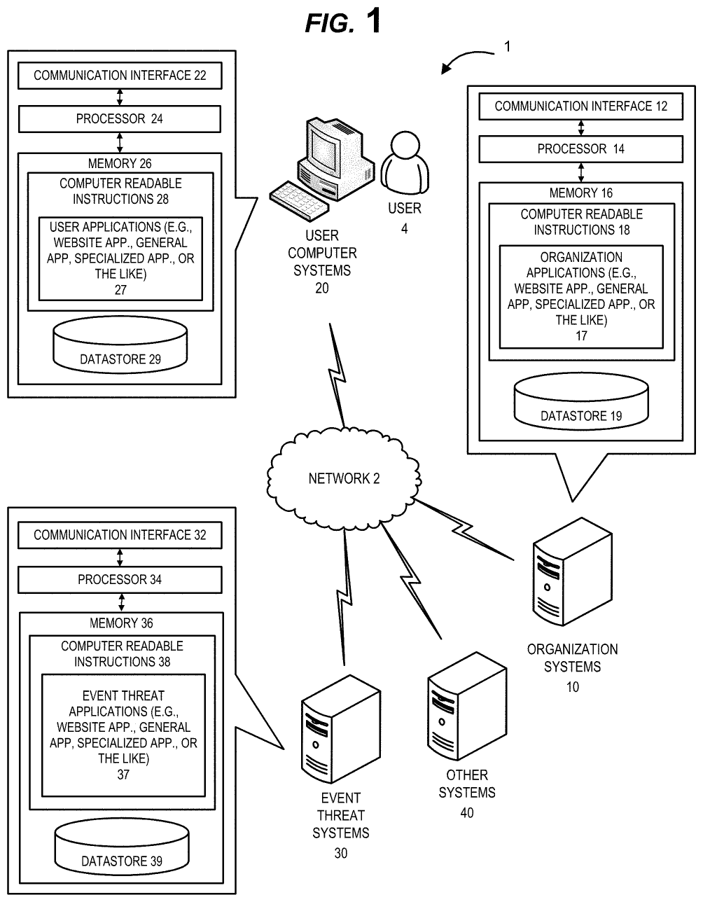

FIG. 1 illustrates an event correlation threat system environment 1, in accordance with embodiments of the invention. As illustrated in FIG. 1, one or more organization systems 10 are operatively coupled, via a network 2, to one or more user computer systems 20, one or more event threat systems 30, and/or one or more other systems 40. In this way, the one or more organization systems 10 may be the systems that run the applications that the organization uses within the organization's operations. The users 4 (e.g., one or more associates, employees, agents, contractors, sub-contractors, third-party representatives, customers, or the like), may include the users 4 that are responsible for and/or use the organization applications 17 and organization systems 10 that are utilized by the organization during the operation of the organization. As such, the one or more organization systems 10 may be utilized by the users 4 for the operation of the organization through communication between the one or more organization systems 10 and the one or more user computer systems 20, and moreover, the users 4 may use the one or more user computer systems 20 to communicate with the one or more event threat systems 20 and/or the one or more other systems 40 (e.g., one or more third-party systems, one or more intermediate systems, or the like). For example, users 4 can create and utilize the threat frameworks with the plurality of events in order to identify and better understand how disparate events when viewed together may result in greater chances for the occurrence of threats. Moreover, the users 4 may utilize the combined event threats to determine how to remediate the threats and how the threats change over time. As such, the one or more user computer systems 20 may communicate with the one or more organization systems 10 directly and/or through the one or more event threat systems 20 in order to utilize the one or more event threat applications 37, as will be described herein.

The network 2 illustrated in FIG. 1 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 1, the one or more organization systems 10 generally comprise one or more communication components 12, one or more processor components 14, and one or more memory components 16. The one or more processor components 14 are operatively coupled to the one or more communication components 12 and the one or more memory components 16. As used herein, the term “processor” generally includes circuitry used for implementing the communication and/or logic functions of a particular system. For example, a processor component 14 may include a digital signal processor, a microprocessor, and various analog-to-digital converters, digital-to-analog converters, and other support circuits and/or combinations of the foregoing. Control and signal processing functions of the system are allocated between these processor components according to their respective capabilities. The one or more processor components 14 may include functionality to operate one or more software programs based on computer-readable instructions 18 thereof, which may be stored in the one or more memory components 16.

The one or more processor components 14 use the one or more communication components 12 to communicate with the network 2 and other components on the network 2, such as, but not limited to, the one or more user computer systems 20, the one or more event threat systems 30, and/or one or more other systems 40. As such, the one or more communication components 12 generally comprise a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors and the like.

As further illustrated in FIG. 1, the one or more organization systems 10 comprise computer-readable instructions 18 stored in the one or more memory components 16, which in one embodiment includes the computer-readable instructions 18 of organization applications 17 (e.g., web-based applications, dedicated applications, specialized applications, or the like that are used to operate the organization, which may be internal and/or external applications). In some embodiments, the one or more memory components 16 include one or more data stores 19 for storing data related to the one or more organization systems 10, including, but not limited to, data created, accessed, and/or used by the one or more organization applications 17. The one or more organization applications 17 may be applications that are specifically used for operating the organization (e.g., the external and/or internal operation of the organization), such as by communicating (e.g., interacting with) the one or more user computer systems 20 and user applications 27, the one or more event threat systems 30 and event threat applications 37 thereof, and/or other systems 40 or applications thereof (e.g., one or more third party systems and/or one or more third party applications, or the like).

As further illustrated in FIG. 1, the one or more user computer systems 20 are operatively coupled, via a network 2, to the one or more organization systems 10, one or more event threat systems 30, and/or one or more other systems 40. As illustrated in FIG. 1, users 4 may try to access the one or more organization systems 10 in order to operate the organization and/or access the one or more event threat systems 30 in order to identify and better understand how disparate events when viewed together may result in greater chances for the occurrence of threats. Moreover, the users 4 may utilize combined event threats to determine how to remediate the threats and how the threats change over time. The users 4 may utilize the one or more user computer systems 20 to communicate with and/or access information from the one or more organization systems 10 and/or from other user computer systems 20, and moreover, communicate with and/or access the one or more event threat systems 30 to perform the tasks described herein. As such, it should be understood that the one or more user computer systems 20 may be any type of device, such as a desktop, mobile device (e.g., laptop, smartphone device, PDA, tablet, watch, wearable device, or other mobile device), server, or any other type of system hardware that generally comprises one or more communication components 22, one or more processor components 24, and one or more memory components 26, and/or the user applications 27 used by any of the foregoing, such as web browsers applications, dedicated applications, specialized applications, or portions thereof.

The one or more processor components 24 are operatively coupled to the one or more communication components 22, and the one or more memory components 26. The one or more processor components 24 use the one or more communication components 22 to communicate with the network 2 and other components on the network 2, such as, but not limited to, the one or more organization systems 10, the one or more event threat systems 30, and/or the one or more other systems 40. As such, the one or more communication components 22 generally comprise a wireless transceiver, modem, server, electrical connection, or other component for communicating with other components on the network 2. The one or more communication components 22 may further include an interface that accepts one or more network interface cards, ports for connection of network components, Universal Serial Bus (USB) connectors and the like. Moreover, the one or more communication components 22 may include a keypad, keyboard, touch-screen, touchpad, microphone, speaker, mouse, joystick, other pointer, button, soft key, and/or other input/output(s) for communicating with the users 4.

As illustrated in FIG. 1, the one or more user computer systems 20 may have computer-readable instructions 28 stored in the one or more memory components 26, which in one embodiment includes the computer-readable instructions 28 for user applications 27, such as dedicated applications (e.g., apps, applet, or the like), portions of dedicated applications, a web browser or other applications that allow the one or more user computer systems 20 to operate the organization and/or use the one or more event threat systems 30 in order create and/or utilize the one or more event threat applications 37 in order to identify, monitor, and/or remediate combined event threats that are not readability identifiable until different events are correlated, as will be described herein.

As illustrated in FIG. 1, the one or more event threat systems 30 may communicate with the one or more organization systems 10 and/or the one or more user computer systems 20, directly or indirectly. The one or more event threat systems 30, as will be described in further detail herein, may be utilized to allow users 4 to create and/or utilize the one or more event threat applications 37 in order to identify, monitor, and/or remediate combined event threats that are not readability identifiable until different events are correlated, as will be described herein. As such, the one or more event threat systems 30 are operatively coupled, via a network 2, to the one or more organization systems 10, the one or more user computer systems 20, and/or the one or more other systems 40. It should be understood that the one or more event threat systems 30 may be a part of the one or more other systems 40 (e.g., one or more third party systems, or the like) or may be a part of the one or more organization systems 10. As such, the one or more event threat systems 30 may be supported by a third-party, by the organization, or a combination thereof.

The one or more event threat systems 30 generally comprise one or more communication components 32, one or more processor components 34, and one or more memory components 36. The one or more processor components 34 are operatively coupled to the one or more communication components 32, and the one or more memory components 36. The one or more processor components 34 use the one or more communication components 32 to communicate with the network 2 and other components on the network 2, such as, but not limited to, the one or more organization systems 10, the one or more user computer systems 20, and/or the one or more other systems 40. As such, the one or more communication components 32 generally comprise a wireless transceiver, modem, server, electrical connection, or other component for communicating with other components on the network 2. The one or more communication components 32 may further include an interface that accepts one or more network interface cards, ports for connection of network components, Universal Serial Bus (USB) connectors and the like.

As illustrated in FIG. 1, the one or more threat systems 30 may have computer-readable instructions 38 stored in the one or more memory components 36, which in some embodiments includes the computer-readable instructions 38 of one or more event threat applications 37 that allow the users 4 to identify, monitor, and/or remediate combined event threats that are not readability identifiable until different events are correlated, as will be described herein.

Moreover, the one or more other systems 40 may be operatively coupled to the one or more organization systems 10, the one or more user computer systems 20, and/or the one or more event threat systems 30, through the network 2. The one or more other systems 40 may be one or more intermediate systems and/or third party systems that communicate with and/or allow communication between the one or more organization systems 10, the one or more user computer systems 20, and/or the one or more event threat systems 30 (e.g., one or more communication components, one or more processor components, and one or more memory components with computer-readable instructions of one or more applications, one or more datastores, or the like). Thus, the one or more other systems 40 communicate with the one or more organization systems 10, the one or more user computer systems 20, the one or more event threat systems 30, and/or each other in same or similar way as previously described with respect to the one or more organization systems 10, the one or more user computer systems 20, and/or the one or more event threat systems 30.

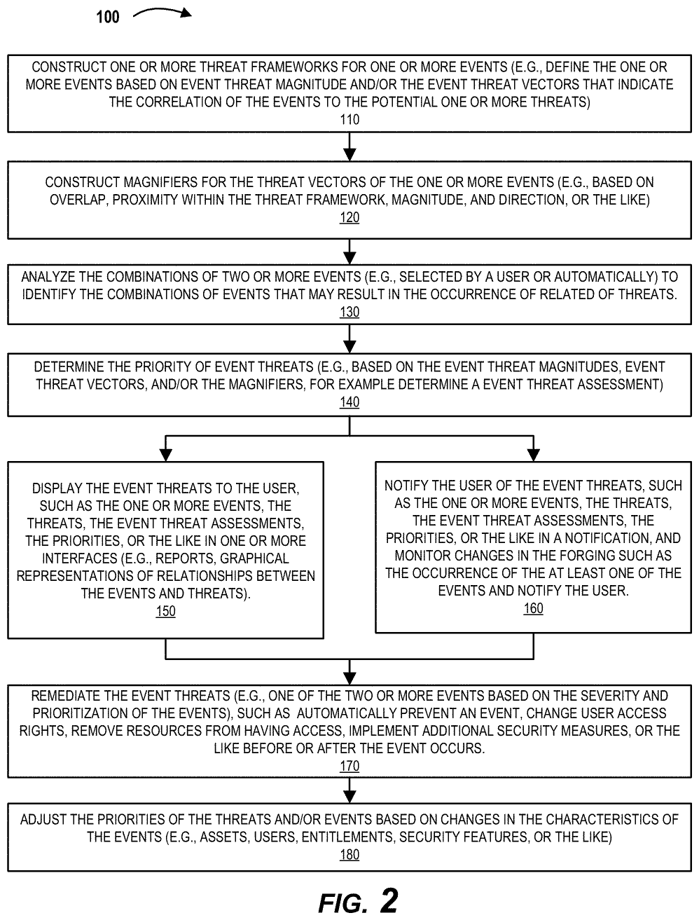

FIG. 2 illustrates a combined event threat process flow in accordance with embodiments of the invention. Block 110 of FIG. 2 illustrates that one or more threat frameworks are constructed. The one or more threat frameworks may include pre-determined frameworks, custom frameworks, or combinations thereof. The one or more threat frameworks may be populated with a plurality of events indicating events that occur or may occur throughout the operation of the organization. The plurality of events may include allowed events that are allowed by the organization, prevented events that are not allowed by the organization, but which may occur, or potential events that could occur, but for which the organization may not be able to monitor. It should be understood that the events may be any type action, entitlement, system, or the like at the organization, as previously described herein.

As previously discussed generally, the events may be anything that is occurring or could occur within an organization, such as any type of information that is stored, the resources (e.g., systems, applications, or the like that the organization utilizes), any action that a system or user may take within the business, entitlements of systems or users within operation of the organization, processes of the organization or lack thereof, security measures in place or lack thereof, or anything else related to the organization. Each of these events within the organization inherently relate to one or more threats that could occur as a result of the one or more events (e.g., past events, current events, or the occurrence of the events in the future). The threats may be any type of threat, such as but not limited to exposure of customer information, potential system failures, potential security threats, potential damage to computer systems based on natural disasters, system downtime, vendor threats, customer attrition, confidential information disclosure, or any other like threat.

Moreover, as previously discussed the threat frameworks may be populated with these events and each of the events comprise event characteristics that may be defined using N-tuples. Tuples are a finite ordered list (e.g., sequenced) of elements, in this case event characteristics that can be used determine the event threat magnitude and/or event threat vector. Moreover, because the event threat magnitude and/or event threat vector may be defined by equations and the event characteristics are the variables used to define the event threat magnitude and/or event threat vector, the N-tuples may be easily updated as the event characteristics change, and thus, the updated event magnitude and/or event vector may be easily determined efficiently to reduce storage requirements, increase processing speeds, and/or improved processing efficiency.

The event characteristics associated with the event may include the resources (e.g., systems, applications, information, or the like) associated with the event, the importance of the resources, the users associated with the event, the user entitlements for the user associated with the event, the security around the event (e.g., what has to be done in order for the event to occur), or the like. The event characteristics may be measured and/or defined and used as variables to determine the event threat magnitude and/or event threats vectors. For example, the type of data, the number of users with access to such data, the resources that use the data, or the like may be assigned a value that can be used to determine the event threat magnitude and/or the event threat vector. The one or more threat frameworks may include one or more events that are plotted in one or more dimensional Cartesian spaces illustrating both the event magnitude and direction of the event with respect to one or more threats. As will be described in further detail herein, the user 4 may access one or more event threat interfaces in order to view the events, the threats associated with the events, the combinations of the events that result in the threats, the priorities of the events and/or threats, and/or to select or deselect the events and threats therein in order to graphically view the relationships thereof, as well as to view how remediation of the events and/or threats impacts the priority of the events and/or threats.

As one example, which will be discussed with respect to the event threat process 100 of FIG. 2, one event may include a user accessing customer information, which could result in the disclosure of customer information. The event magnitude for this particular event may be low because while the severity could be high (e.g., user having access to customer information the likelihood of the event resulting in the threat is low (e.g., user access to the customer information is monitored, processes are followed to restrict capture of the customer information and/or electronic transmission of the customer information). However, this particular event is correlated well with the potential threat (e.g., the event of accessing customer information is correlated with the occurrence of disclosure of customer information) and thus, the event vector may be 95% correlated with the threat. Alternatively, the event of accessing customer information is virtually unrelated to the threat of system downtime (e.g., accessing customer information is unrelated to the organization system not operating properly), and thus, these events may be uncorrelated (0%) with this threat. Alternatively, the event of accessing customer information may be tangentially related to the threat of losing business, because should the customer information get into the wrong hands the customers may not want to do business with the organization, and thus, accessing customer information may be partially correlated (65%) with the threat of the losing business. It should be understood that many different events may be populated within the threat framework. For example, another event may be a user accessing a file sharing application. This event may have its own event threat magnitude and event threat vector for one or more threats. As will be discussed herein, while each of these events may be acceptable independently, when each of these events occur by the same user, on the same resource, within a particular time frame, or in accordance with some event characteristic, the combination of these events greatly increases the occurrence of the threat depending on the event characteristics of each of the events. For example, if the users for each of the events are different there may be less of a threat than if the same user is involved in each of the events.

As illustrated by block 120, in addition to the development of the event threat framework, magnifiers may be developed for the combination of events within the event threat network. The magnifiers may provide a representation of the degree to which the threat is magnified based on the combination of the occurrence of the two or more events. The magnifiers may be based on overlap, proximity, or the like of the events (e.g., or the characteristics thereof). For example, the distance of the events from each other and/or the distance from the origin of the threat may be used to apply a magnifier to the combinations of the events.

Returning to the example discussed herein, should a single user have access to customer information and that user accesses a file sharing application, then there is overlap between the events (e.g., the same user is involved in both events on the same computer), and thus, the threat priority may be a high priority (e.g., priority to investigate and/or remediate—restrict access). Alternatively, should a first user that has access to customer information be in the same group within the organization as a second user that accesses the file sharing application, the occurrence of the threat is less likely but still possible and the proximity between the events is that the users may be familiar with each other and/or use the same resource for both events. As such, the threat priority may be a medium priority (e.g., investigate). However, should the user that has access to the customer information have no relationship with the user that accesses the file sharing application, then the occurrence of the threat based on these events may have a low threat priority (e.g., no action needed, but monitor). As such, the magnifiers may be utilized within the event threat framework based on the correlation of the events and/or the event characteristics thereof.

It should be understood that a user 4 may create the event threat framework (e.g., new frameworks, edit current frameworks, or the like), and/or machine learning and/or artificial intelligence may be utilized (e.g., using historical event correlation based on event characteristics, or the like) in order to create at least a portion of the event threat framework and/or the magnifiers for the two or more events.

As further illustrated in block 130 of FIG. 2, selection of the two or more events may be received by the systems described herein (e.g., user, organization, and/or event threat systems). For example, a user 4 may select the combination of events to analyze or the systems may automatically iteratively analyze the combinations of events within the one or more event threat frameworks. It should be understood that multiple events may be selected; however, while the combination of two or three events may be provide feedback that can be illustrated easily (e.g., in reports, graphically 2-D or 3-D, or the like), utilizing many events may not provide clear information related to the events that most affect the likelihood of the occurrence of the threat. It should be understood that the analysis of the events may be used to evaluate different combinations of events and determine priorities for mitigation of one or more threats based on combinations of two or more events. In some embodiments of the invention analysis may include an event threat assessment (e.g., ranking, score, value, reach, connection to other threats, or the like). The assessment may be based at least in part on the event threat magnitude, the event threat vector, and/or the multiplier for the combination of the events.

Block 140 of FIG. 2 illustrates that priorities for the event threats are determined from the analysis of different combinations of the two or more events (e.g., based on the event magnitudes, event vectors, and/or event magnifiers) and/or the event threat assessment for the combinations of the events. The priorities may be based on threshold values and/or may be determined relative to the different combinations of events. The priorities may be utilized to determine remediation plans for the event threats (e.g., mitigation of the potential threat, changes to resources, changes to entitlements, or the like), as will be described in further detail herein.

Blocks 150 and 160 of FIG. 2 illustrate that the event threats (e.g., the one or more threats, the two or more events associated with the one or more events, the event threat assessments, the priorities of each, or the like) may be presented to one or more users in a number of different ways. With respect to block 150 of FIG. 2, the event threats may be presented to the user 4 through the use of one or more event threat interfaces through which the user 4 may interact. For example, in some embodiments of the invention the one or more interfaces may be graphical user interfaces (“GUI”) that graphically represent the one or more events with respect to the one or more threats, the event threat assessments, the priorities of the foregoing, and/or combinations thereof. For example, a single event may be illustrated in the graphical user interface with respect to all of the threats for which the event is associated (or the threats to which the event is a contributor), along with the event magnitude (e.g., severity and likelihood) and event vector for the associated threat (e.g., illustrating the correlation with the threats). Alternatively or additionally, a threat may be graphically illustrated along with all of the events that are associated with the threat (or the events that are the greatest contributors to the threat). Moreover, combinations of events and/or threats related to events may be graphically displayed to the user 4. It should be further understood that the changes in the threats and/or the two or more events, including the priorities thereof, may be displayed graphically over time illustrating how the threats, the events that could result in the occurrence of the threats (or the changes in the events that could cause the threat) may be displayed to the user.

As illustrated by block 160 of FIG. 2, it should be further understood that notifications (e.g., correspondence such as but not limited to text, voicemail, e-mail, pop-up, identification on a screen of a mobile device, or the like) may be sent to the user 4. It should be understood that the notifications may be made automatically to the user through the user computer systems or may be requested by the user 4. For example, notifications may be automatically displayed to the user when event threats change based on changes made to the events or event characteristics, which may result in changes to the threats, priorities, or the like. Moreover, in some embodiments the one or more event threat systems 30 may monitor changes in the events, such as the occurrence of an event or combination thereof (e.g., user accessing a file sharing website, user sending information that looks like customer information through an e-mail, or the like). It should be understood that when an event occurs, it may change the analysis of the event threat assessment for the combinations of events, and as such, change the potential for the occurrence of a threat. In some embodiments, the user 4 may select the threats and/or combinations of events for which the user 4 would like to be notified when a change occurs, alternatively, the combinations of events that have the largest priorities (or that meet a threshold) may be automatically presented to the user 4 when the combination of the events occur.

The notifications to the user 4 upon the occurrence of one or more events and/or changes to the event threats may provide the organization, and/or the users 4 within the organization, the ability to prevent or mitigate the event threats (e.g., either before or after the events occur). For example, the event threat system 30 may be utilized to identify combinations of events that most likely could lead to the occurrence of one or more threats, and in particular to the combinations of the events that the organization might not have been able to identify before implementation of the systems. Furthermore, the notifications of the occurrence of the one or more events allows the organization to quickly identify the occurrence of potential event threats in the future that may be remediated before the occurrence of the event threats.

FIG. 2 further illustrates in block 170, that remediation of the threats may occur based on the priority of the event threats, or based on the notifications associated with the occurrence of the one or more events for the event threats. It should be understood that the remediation may relate to threats that could be severe, but unlikely to occur, to threats that are not severe, but are likely to occur, or more importantly threats that are both severe and likely to occur. Alternatively or additionally, the priorities for remediation may relate to an event, or combination of events, that may result in the occurrence, severity, likelihood, and/or the combination thereof of the events. Returning to the example discussed herein, in order to remediate the potential occurrence of the event threat of the loss of customer information, the system may remediate (e.g., prevent, reduce the potential thereof, or the) the event threat by taking a number of actions automatically or with user approval. Such remediation may include placing limits on the customer information to which the user has access (e.g., may only access anonymous information, a portion of the information, or the like), monitor any transfer of customer information by any means from the resources of the selected user, block websites that the user can access, automatically scan and/or review any communication that includes information that may contain customer information, or the like.

Block 180 of FIG. 2 illustrates that the priorities of the event threats and/or the event threat assessment thereof may be adjusted based on changes to the events and/or event characteristics thereof. It should be understood that the changes to the priorities and/or event threat assessments may be made based on an iterative analysis of combinations of events with respect to changes to the characteristics associated with the events. That is, each of the event characteristics may change over time as the organization makes changes throughout the organization. In some embodiments of the invention, due to the creation of the N-tuples for the plurality of events within the one or more threat frameworks, any changes to the events may be easily updated dynamically to determine how such changes affect the threats, two or events associated therewith, and/or the priority of the forgoing. It should be understood that the changes to the events may relate to changes to the resources, user, user entitlements, security, procedures, or the like. Returning to the customer information example discussed herein, should more users gain access to the customer information (e.g., legally as the administrator adds more users to the database), should the organization allow users to access file sharing websites (e.g., for legitimate business purposes), should additional customer information be added to the database (e.g., additional sensitive information is captured and stored), or the like, the priority for the event threat may increase. Moreover, should security measures be implemented (e.g., preventing the use of USB drives, requiring multiple user acceptance to access the information), should the number of users with access to the customer information be reduced, should particular websites be restricted, or the like, the priority for the threat may decrease. It should be understood that in some embodiments the event threat systems 30, or other systems 40, may monitor the changes within the organization that may change future events, which when combined with other events may change the priority of the event threat. As such, when a change is made to a resource, such as a configuration change to a system, application, or the like, entitlement rights of users, policies changes, or other like change, the event threat system 30 may automatically adjust the events within the threat framework, and automatically update the event threat measurement and/or priority of the event threats. It should be understood that the use of the N-tuples allow for adjustments to the events to investigate how changes to the event characteristics change the priorities of the event threats.

It should be understood, that the systems described herein may be configured to establish a communication link (e.g., electronic link, or the like) with each other in order to accomplish the steps of the processes described herein. The link may be an internal link within the same entity (e.g., within the same organization) or a link with the other systems. In some embodiments, the one or more systems may be configured for selectively responding to dynamic inquires. These feeds may be provided via wireless network path portions through the Internet. When the systems are not providing data, transforming data, transmitting the data, and/or creating the reports, the systems need not be transmitting data over the Internet, although it could be. The systems and associated data for each of the systems may be made continuously available, however, continuously available does not necessarily mean that the systems actually continuously generate data, but that a systems are continuously available to perform actions associated with the systems in real-time (i.e., within a few seconds, or the like) of receiving a request for it. In any case, the systems are continuously available to perform actions with respect to the data, in some cases in digitized data in Internet Protocol (IP) packet format. In response to continuously receiving real-time data feeds from the various systems, the systems may be configured to update actions associated with the systems, as described herein.

Moreover, it should be understood that the process flows described herein include transforming the data from the different systems (e.g., internally or externally) from the data format of the various systems to a data format associated with a particular display. There are many ways in which data is converted within the computer environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may convert to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

As will be appreciated by one of skill in the art in view of this disclosure, embodiments of the invention may be embodied as an apparatus (e.g., a system, computer program product, and/or other device), a method, or a combination of the foregoing. Accordingly, embodiments of the invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the invention may take the form of a computer program product comprising a computer-usable storage medium having computer-usable program code/computer-readable instructions embodied in the medium (e.g., a non-transitory medium, or the like).

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the invention may be written in an object oriented, scripted or unscripted programming language such as Java, Pearl, Python, Smalltalk, C++ or the like. However, the computer program code/computer-readable instructions for carrying out operations of the invention may also be written in conventional procedural programming languages, such as the “C” programming language or similar programming languages.

Embodiments of the invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. An event correlation threat system for remediation of threats, the system comprising:
one or more memory components having computer readable code stored thereon; and
one or more processing components operatively coupled to the one or more memory components, wherein the one or more processing components are configured to execute the computer readable code to:
access two or more events and one or more threats from one or more threat frameworks;
determine one or more combined event threats for the two or more events;
determine a combined event threat assessment for the one or more combined event threats based on an event threat magnitude and an event threat vector for each of the two or more events; and
present the one or more combined event threats to a user.

2. The system of claim 1, wherein the one or more processing components are configured to execute the computer readable code to:
construct the one or more threat frameworks;
define a plurality of events within the one or more threat frameworks, wherein defining the plurality of events comprises defining event characteristics within an N-tuple for each of the plurality of events;
determine the event threat magnitude and the event threat vector for each of the plurality of events based at least in part on the N-tuple with the event characteristics.

3. The system of claim 2, wherein the one or more threat frameworks are one or more dimensional Cartesian spaces of the plurality of events.

4. The system of claim 3, wherein determining the combined event threat assessment for the one or more combined event threats comprises:
determining directions of the event threat vector for the two or more events within the one or more dimensional Cartesian spaces that are directed to a threat from the one or more threats;
determining the event threat magnitude for the one or more threats;
combining event threat magnitudes for the two or more events for the threat based on event threat vectors for the threat; and
applying a magnifier from a plurality of magnifiers for the event threat magnitudes to determine the combined event threat assessment.

5. The system of claim 1, wherein the one or more combined event threats comprise a plurality of combined event threats, and wherein the one or more processing components are configured to execute the computer readable code to:
determine priorities for the plurality of combined event threats based on the combined event threat assessment for the plurality of combined event threats.

6. The system of claim 2, wherein presenting the one or more combined event threats to the user comprises transmitting for display an event threat interface illustrating a graphical representation of the plurality of events, the one or more threats, and the one or more combined event threats.

7. The system of claim 2, wherein presenting the one or more combined event threats to the user comprises transmitting a notification to the user of the plurality of events, the one or more threats, and the one or more combined event threats.

8. The system of claim 1, wherein the one or more processing components are configured to execute the computer readable code to:
receive a selection from the user for the two or more events, in order to determine the one or more combined event threats for the two or more events selected.

9. The system of claim 1, wherein the one or more processing components are configured to execute the computer readable code to:
automatically receive a selection from a system for the two or more events in order to determine one or more combined threats for the two or more events selected.

10. The system of claim 1, wherein the one or more processing components are configured to execute the computer readable code to:
monitor the two or more events;
determine when at least one of the two or more events occur; and
notify the user of an occurrence of the at least one of the two or more events or prevent one or more of the two or more events.

11. The system of claim 1, wherein the one or more processing components are configured to execute the computer readable code to:
automatically remediate the one or more combined event threats by editing one or more configurations for one or more resources or entitlements for users associated with the two or more events to reduce the combined event threat assessment for the two or more events.

12. The system of claim 2, wherein the one or more processing components are configured to execute the computer readable code to:
identify changes to the event characteristics for at least one of the two or more events;
implement updated event characteristics within the N-tuple for the two or more events within the one or more threat frameworks; and
determine an updated event threat assessment for the two or more events based on the updated event characteristics.

13. A computer implemented method for an event correlation threat system for remediation of threats, the method comprising:
accessing, by one or more processing components, two or more events and one or more threats from one or more threat frameworks;
determining, by the one or more processing components, one or more combined event threats for the two or more events;
determining, by the one or more processing components, a combined event threat assessment for the one or more combined event threats based on an event threat magnitude and an event threat vector for each of the two or more events; and
presenting, by the one or more processing components, the one or more combined event threats to a user.

14. The method of claim 13, further comprising:
defining, by the one or more processing components, a plurality of events within the one or more threat frameworks, wherein defining the plurality of events comprises defining event characteristics within an N-tuple for each of the plurality of events; and
determining, by the one or more processing components, the event threat magnitude and the event threat vector for each of the plurality of events based at least in part on the N-tuple with the event characteristics.

15. The method of claim 14, wherein the one or more threat frameworks are one or more dimensional Cartesian spaces of the plurality of events.

16. The method of claim 15, wherein determining the combined event threat assessment for the two or more events comprises:
determining directions of the event threat vector for the two or more events within the one or more dimensional Cartesian spaces that are directed to a threat from the one or more threats;
determining the event threat magnitude for the one or more threats;
combining event threat magnitudes for the two or more events for the threat based on event threat vectors for the threat; and
applying a magnifier from a plurality of magnifiers for the event threat magnitudes to determine the combined event threat assessment.

17. The method of claim 14, wherein presenting the one or more combined event threats to the user comprises transmitting for display an event threat interface illustrating a graphical representation of the plurality of events, the one or more threats, and the one or more combined event threats.

18. The method of claim 13, further comprising:
monitoring, by the one or more processing components, the two or more events;
determining, by the one or more processing components, when at least one of the two or more events occur; and
notifying, by the one or more processing components, the user of an occurrence of the at least one of the two or more events or prevent one or more of the two or more events.

19. The method of claim 14, further comprising:
identifying, by the one or more processing components, changes to the event characteristics for at least one of the two or more events;
implementing, by the one or more processing components, updated event characteristics within the N-tuple for the two or more events within the one or more threat frameworks; and
determining, by the one or more processing components, an updated event threat assessment for the two or more events based on the updated event characteristics.

20. A computer program product for an event correlation threat system for remediation of threats, the computer program product comprising at least one non-transitory computer-readable medium having computer-readable program code portions embodied therein, the computer-readable program code portions comprising:
an executable portion configured to access two or more events and one or more threats from one or more threat frameworks;
an executable portion configured to determine one or more combined event threats for the two or more events;
an executable portion configured to determine a combined event threat assessment for the one or more combined event threats based on an event threat magnitude and an event threat vector for each of the two or more events; and
an executable portion configured to present the one or more combined event threats to a user.
